(19) United States
(12) Patent Application Publication
(10) Pub. No.: US 2025/0232595 A1
(43) Pub. Date: Jul. 17, 2025

(54) SYSTEMS AND METHODS FOR COOPERATIVE PERCEPTION

(71) Applicants: Weihua ZHUANG, Waterloo (CA); Xuehan YE, Richmond Hill (CA); Kaige QU, Waterloo (CA); Xuemin SHEN, Waterloo (CA); HUAWEI TECHNOLOGIES CANADA CO., LTD., Kanata (CA)

(72) Inventors: Weihua ZHUANG, Waterloo (CA); Xuehan YE, Richmond Hill (CA); Kaige QU, Waterloo (CA); Xuemin SHEN, Waterloo (CA); Xu LI, Kanata (CA)

(73) Assignee: HUAWEI TECHNOLOGIES CANADA CO., LTD., Kanata (CA)

(21) Appl. No.: 19/068,689

(22) Filed: Mar. 3, 2025

Related U.S. Application Data
(63) Continuation of application No. PCT/CA2022/051386, filed on Sep. 20, 2022.

(51) Int. Cl. G06V 20/58; G06F 9/50

(52) U.S. Cl. CPC G06V 20/58; G06F 9/5027

(57) ABSTRACT

A method, apparatus and system for cooperatively classifying objects in an autonomous vehicle environment are provided. A controller receives data quality indicators from multiple devices. Each data quality indicator reflects quality of an instance of object sensing data held by a device. Each device determines its data quality indicators based on its own sensor data and indications of object bounding regions. The controller makes decisions based at least in part on the data quality indicators, such as decisions on which instances of object sensing data are to be used for an object classification task, which device is to perform the object classification task, any downsampling of sensor data to be performed prior to object classification, and allocations of resources for use in object classification. The decision may be made by solving an optimization problem.

### CROSS-REFERENCE TO RELATED APPLICATION

This application is a continuation of International Application No. PCT/CA2022/051386, filed on Sep. 20, 2022, the disclosure of which is hereby incorporated by reference in its entirety.

### TECHNICAL FIELD

The present invention pertains in general to automatic object perception and in particular to a method and apparatus for classifying objects within a region of interest of a device such as an autonomous driving vehicle.

### BACKGROUND

Autonomous vehicles (AVs) in autonomous driving scenarios rely on substantially real-time information about surrounding environment containing various objects and environmental conditions. This allows the AV controllers to maintain situational awareness that includes identifying objects in the surrounding environment. Because a single vehicle has limited perspective, adequate situational awareness may require obtaining information from other sources, such as other AVs or stationary sensors. Therefore, obtaining and processing such real-time information can involve sharing large amounts of raw sensing data between AVs (vehicle-to-vehicle or V2V) and between AVs and stationary sensors or servers as part of vehicle edge computing (VEC). This can require substantial and reliable communication capabilities for transmission of data and can require computing resources that may not be available at an AV for processing such large amounts of sensing data while maintaining substantially real-time situational awareness. To date, proposed solutions for promoting situational awareness among multiple AVs by sharing data can be resource inefficient or even impractical.

Therefore there is a need to provide a method and apparatus that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a method, apparatus and system for cooperatively classifying objects in a region of interest of at least one target device, such as a target autonomous vehicle (AV) by a plurality of devices.

In embodiments, a controller may be configured to receive object sensing data quality indicators determined by a plurality of devices including a target device. Each object sensing data quality indicator may be indicative of quality of a respective instance of object sensing data, held by a respective one of the plurality of devices and indicative of a respective object belonging to a set of objects in a region of interest of at least the target device. The controller may be configured to provide to at least one of the plurality of devices, an indication of one or more of the instances of the object sensing data to be used in each of one or more object classification tasks for classifying a respective one of the set of objects. A system for cooperative classification of objects is provided and may include the plurality of devices and the controller. In embodiments, the devices may then perform the object classification tasks.

In embodiments, providing the indication of one or more of the instances of the object sensing data may include the controller providing, to a particular device of said at least one of the plurality of devices, a data selection indication. The data selection indication may be indicative that the instance of object sensing data, held by said particular device and indicative of a particular object belonging to the set of objects, is to be used in a particular corresponding one of the object classification tasks. The controller may select the particular device based at least in part on object sensing data quality indicators indicative of quality of respective instances of object sensing data held by the particular device.

In embodiments, the controller may provide to said at least one of the plurality of devices, one or more task placement indications. Each task placement indication may indicate that a specified one of the object classification tasks is to be performed at a specified one of the plurality of devices. The task placement indications may be determined jointly with the indication of one or more of the instances of the object sensing data to be used in each of one or more object classification tasks. At least one of the task placement indications may include or be integrated together with the indication of the one or more of the instances of the object sensing data to be used in each of the one or more object classification tasks.

In embodiments, the controller may allocate resources for use in each of the one or more object classification tasks. The resources may include one or both of: computing resources to be used by the specified one or specified ones of the plurality of devices in support of an associated one or more of the object classification tasks; and communication resources to be used for communication between the specified one of the plurality of devices and another specified one of the plurality of devices, or between specified pairs of the plurality of devices, in support of the associated one or more of the object classification tasks. The controller may determine allocation of resources jointly with determining the indication of one or more of the instances of the object sensing data to be used in each of one or more object classification tasks. The resources may be allocated at least in part to satisfy that a combination of: a computing time for completion of each of the associated one or more of the object classification tasks, and a communication time for communication between the specified one of the plurality of devices and other specified one of the plurality of devices in support of each of the associated one or more of the object classification tasks, will be at or below a predetermined threshold. The controller may communicate indications of the allocated resources to one or more of the plurality of devices, the plurality of devices using the allocated resources in performing the object classification tasks and refraining from using more than the allocated resources in performing the object classification tasks. At least one of the plurality of devices may then perform the specified one(s) of the object classification tasks, for example according to the task placement indications.

In embodiments, the controller may provide to at least one of the plurality of devices, one or more data resolution indications. Each data resolution indication may indicate that an associated one of the instances of the object sensing data to be used in each of one or more object classification tasks is to be downsampled by a specified degree prior to use in an associated object classification task. The use of the associated one of the instances of the object sensing data may include transmission of object sensing data between members of the plurality of devices when required. The devices may then downsample object sensing data by the specified degree(s) according to the data resolution indication(s).

In embodiments, the controller may allocate resources so as to minimize or limit a total resource consumption cost. The total resource consumption cost may include a weighted or unweighted sum of the computing resources to be used by each specified one of the plurality of devices in support of all associated object classification tasks, and a weighted or unweighted sum of the communication resources to be used for communication between each specified pair of the plurality of devices in support of all object classification tasks.

In embodiments, the object classification tasks may be performed by said at least one of the plurality of devices in compliance with indications, allocations, or both indications and allocations provided by the controller. Such indications may include the indication of one or more of the instances of the object sensing data to be used in each of one or more object classification tasks.

In embodiments, a bounding region module may be provided. The bounding region module may be configured to determine a bounding region for the object to be indicated by the instance of object sensing data. Determining the instances of object sensing data may include, for each instance of the object sensing data, the bounding region module sending bounding region parameters for the bounding region to each of the plurality of devices. Each one of the plurality of devices may determine the respective instance of object sensing data from raw sensing data obtained by said one of the plurality of devices, using the bounding region parameters. The bounding region module may be located at the controller or said at least one of the plurality of devices.

In embodiments, the indication of the one or more instances of the object sensing data may be provided to satisfy that an estimated classification accuracy of each of the object classification tasks is at or above a predetermined classification accuracy threshold. The estimated classification accuracy may be determined by the controller based at least in part on the respective object sensing data quality indicators for each object classification task, in combination with dimensions of the bounding regions for the objects received by the controller from the bounding region module. The estimated classification accuracy of each object classification task may be indicated to one or more of the devices by the controller.

In embodiments, the region of interest may be a region of interest of a plurality of target devices including the target device. The region of interest may be a union of sub-regions, each sub-region being a region of interest for a corresponding one of the plurality of target devices. The plurality of devices may include the plurality of target devices.

In embodiments, at least the indication of one or more of the instances of the object sensing data may be determined based on context information. The context information may include one or more of: network topology context information, resource availability context information, and quality of service (QoS) requirement context information.

According to another embodiment of the present disclosure, there is provided a computer program product that includes instructions which, when executed by a computer, cause the computer to implement any of the methods, fully or in part, as disclosed herein.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 illustrates a scenario employing systems and methods for classifying objects, according to an embodiment of the present disclosure.

FIG. 2 illustrates bounding regions for objects of FIG. 1, according to an embodiment of the present disclosure.

FIG. 3 illustrates a partitioned bounding region, according to an embodiment of the present disclosure.

FIG. 4 illustrates operations supporting object classification, according to an embodiment of the present disclosure.

FIG. 5A illustrates object sensing data of a given object, Object0, obtained by a given device AV0 of FIG. 1, according to an embodiment of the present disclosure.

FIG. 5B illustrates object sensing data of Object0 obtained by device AV0 and device AV1 of FIG. 1, according to an embodiment of the present disclosure.

FIG. 6 illustrates components of a system for classifying objects, according to an embodiment of the present disclosure.

FIG. 7 illustrates a cooperative perception mechanism for classifying objects, according to an embodiment of the present disclosure.

FIG. 8 illustrates an apparatus provided in accordance with an embodiment of the present disclosure.

It will be noted that throughout the appended drawings, like features are identified by like reference numerals.

### DETAILED DESCRIPTION

Embodiments of the present disclosure pertain to methods, apparatus and systems for classifying objects in a region of interest of a target device, such as a target autonomous vehicle (AV). The target device can alternatively be another mobile device, such as but not necessarily limited to a robot or hand-held device (e.g. smart phone). Thus, some embodiments of the present disclosure pertain to autonomous driving, but other embodiments may pertain to other applications in which object classification is required. The classification is performed cooperatively by a plurality of devices.

In embodiments, a target device is an AV requiring classification of objects within its region of interest. The target device may be stationary. The target device may be mobile. The target device may be accelerating or decelerating.

In embodiments, there is provided a plurality of devices [symbol] . The devices are associated with a region of interest of at least one target device and include the (at least one) target device. A device n may be a mobile (e.g. an AV) or stationary device connected to a (communications) network and having a sensing capability to sense or detect objects (e.g. within a predetermined sensing range), a computing capability, or both. A device may be a (e.g. stationary) roadside unit (RSU). The RSU may be in communication with an edge server providing computing resources. The RSU may itself include local computing resources. A device may be an edge server with communication resources. A device may be within the region of interest of the target device. A device may be outside the region of interest of the target device while being able (e.g. having sufficient sensing range) to sense objects within the region of interest of the (at least one) target device.

In embodiments, a device (an AV, another RSU, an edge server) that is outside the communication range of AVs associated with a particular region of interest may be involved in the systems and methods of the present disclosure pertaining to object classification within the particular region of interest, for example, via one or more neighboring RSUs and/or ground stations enabling relaying of information and/or data.

In embodiments, the region of interest is a physical area containing a set of objects [symbol] to be classified using approaches disclosed herein. The set of objects [symbol] includes at least one object m. Non-limiting examples of objects include autonomous vehicles (other than the target device), other motorized vehicles (e.g. cars, scooters, trucks, trailers, agricultural equipment), emergency and road assistance vehicles, pedestrians, animals and wildlife, and non-motorized vehicles (e.g. bicycle, skateboard). An object may be in contact with the ground. An object may be airborne (e.g. a flying sheet of ice from another vehicle, a bird). An object may be stationary or mobile. A stationary object may be, for example, a roadside pylon, a roadside safety triangle, and any other object on the ground (e.g. road, sidewalk, road shoulder) in the region of interest. Classification may involve and be applicable to determining various characteristics of the object, for example its type, motion, size, shape, etc.

In embodiments, the region of interest may be a region of interest of a plurality of target devices including the target device. Such region of interest may be a union of sub-regions, where each sub-region is a respective region of interest for a corresponding one of the plurality of target devices. A plurality of devices obtaining object sensing data and determining object sensing data quality indicators may include such plurality of target devices including the target device.

In embodiments, the region of interest may be a three-dimensional (3-D) geographic region, a geometric region (e.g. a cuboid, a spheroid), or a combination thereof. The region may have a uniform boundary, a non-uniform boundary, or a combination thereof. The region of interest may include the target device. The region of interest may be primarily or substantially in front of the target device along its direction of movement. The region of interest may include regions to the side and rear of the target device, for example, to detect and classify objects in a blind spot of the target device. The region of interest may be relative to the target device or a plurality of target devices each requiring object classification within a respective sub-region of each target device. Nearby sub-regions defining respective regions of interest may be adjacent, may be separated by a gap, may partially overlap, or combination thereof. A smaller one or more sub-regions may be included in a larger sub-region.

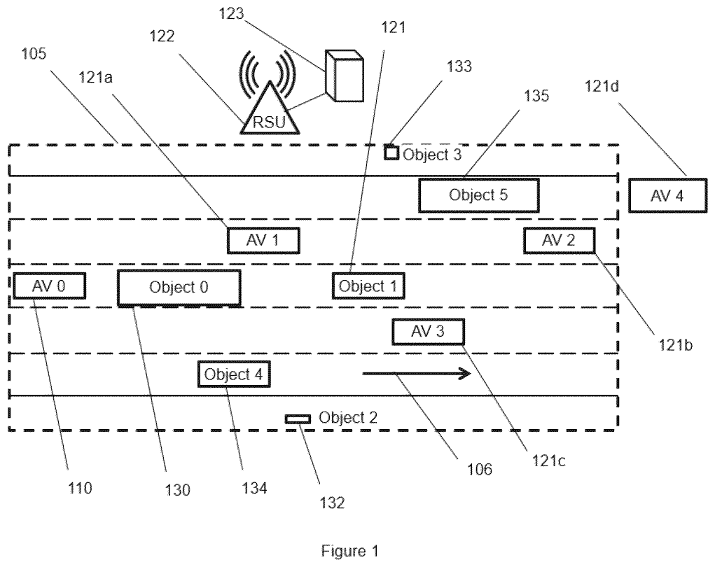

FIG. 1 illustrates an example scenario where object classification is required by at least one AV, namely the target device. The scenario includes a target device AV0 110 in the region of interest 105. A first AV AV1 121a, a second AV AV2 121b, and a third AV AV3 121c are also located within the region of interest 105. A fourth AV AV4 121d is outside the region of interest 105, but sufficiently close to it (or has a sufficient sensing range) to obtain sensing data of at least some of the objects in the region of interest 105. Another AV may be at the boundary of the region of interest (not shown).

As further shown in FIG. 1, a roadside unit RSU 122 is located outside the region of interest. The RSU is in communication with all AVs within its communication range, which, for simplicity includes all AVs shown in FIG. 1. The RSU 122 is further in communication with an edge server 123. In an embodiment, an RSU providing relay functionality may not need connection to an edge server (not shown). In embodiments, zero, one, two or more RSUs may be present. RSUs are not necessarily connected to edge servers.

The target device AV0 110 requires classification of six objects in the region of interest 105. The region of interest 105 includes a road where AVs and objects move in one direction of motion 106. A first object Object0 130 (e.g. a truck) is in front of the target device AV0 110 in the direction of motion 106. A second object Object1 121 (e.g. a car) is in front of the first object Object0 130 in the direction of motion 106. A third object Object2 132 (e.g. a cyclist) is on a right side road shoulder and may be stationary or mobile. A fourth object Object3 133 (e.g. a pedestrian) is on a left side road shoulder and may be stationary or mobile. A firth object Object4 132 (e.g. a car) is to the front right of the target device AV0 110 in the direction of motion 106. A sixth object Object5 135 (e.g. a truck) is to the front left of the target device AV0 110 in the direction of motion 106.

In embodiments, each device in the plurality of devices may obtain (e.g. using one or more sensors thereof, such as LIDAR sensors) raw sensing data Dₙ for objects or an environment within its sensing range. Raw data D, may include all sensing data obtained by the device n. Raw sensing data is relatively unprocessed in contrast to other forms of sensing data discussed herein, however the raw sensing data may already be processed to some degree. From its raw sensing data, the device n may determine (e.g. obtain, extract, filter out, select) object sensing data Dₙ^{(m)} for each object m in the region of interest (e.g. as long as the object is within a sensing range and at least partially unobstructed by other objects or devices). It should be noted that each particular AV in the region of interest or capable of providing sensing data for the region of interest may share information about itself (e.g. related to the particular AV's location, dimensions, travel speed, travel direction, planned travel path, etc.) directly with other devices (including other AVs). Therefore, in the context of the present disclosure, objects m in the region of interest may exclude AVs if such direct sharing of own information among AVs is utilized. Object sensing data may be determined using respective bounding region parameters ĉₘ for each object m in the region of interest and may include respective raw sensing data for each object in the region of interest. The raw sensing data of the device does not necessarily include raw sensing data for all objects in the region of interest, for example, due to limited sensing range of the device. For example, the portion of all raw sensing data which pertains to points within a bounding region for object m may be determined to be the object sensing data Dim). A LIDAR datum may pertain to a certain point when it is obtained by reflecting light off a surface at that point.

In embodiments, object sensing data is used in respective object classification tasks, resulting in lower communication resource consumption compared to use of raw data from each device. This is because only the object sensing data (or further processed or abstracted data representative thereof) is communicated, rather than the entire raw sensing data. The selection (or determining) of one or more specific devices to provide object sensing data for a classification task of a respective object may be based at least in part on quality of respective object sensing data held by each specific device.

In the illustrative embodiment shown in FIG. 1, each of the AVs may provide object sensing data for at least some of the six objects in the region of interest 105 within their respective sensing range and taking into consideration various obstacles (e.g. other devices, vehicles). For example, an AV3 121c may provide object sensing data of: the front and right side of Object0 130; the front and right side of Object1 121; the front and left side of Object2 132; the front and right side of Object0 130; the right side of Object3 133 (data may have low quality due to Object3 133 being further away from AV3 121c and partially blocked by Object1 121); the front and left side of Object4 134; and the right side of Object5 135 (data may have lower quality due to Object5 135 being partially blocked by Object1 121). In another example, AV4 121d may be unable to provide any object sensing data of Object4 134 because Object4 134 is at least partially blocked by each of AV2 121b, AV3 121c, and Object1 121.

The target device0 110 may be unable to obtain any object sensing data of Object1 121 because it is blocked by Object0 130. However, object sensing data of Object1 121 may be provided by AV3 121c (front and right side of Object1 121), AV1 121a (rear and left side of Object1 121), and AV2 121b (front and right side of Object1 121).

In embodiments, spatial location of an object m can be represented, for example, by a 3-D cuboid bounding region containing the object. The estimated bounding region parameters ĉₘ of such bounding region may be characterized by a 9-tuple, ĉₘ=(xₘ, yₘ, zₘ, lₘ^{(x)}, lₘ^{(y)}, lₘ^{(z)}, δₘ^{(x)}, δₘ^{(y)}, δₘ^{(z)}). Here, xₘ, yₘ, zₘ specify the 3-D location coordinates of the cuboid region center; lₘ^{(x)}, lₘ^{(y)}, lₘ^{(z)}, specify the lengths of the cuboid region along the x, y and z axes (e.g. prior to rotation), and δₘ^{(x)}, δₘ^{(y)}, δₘ^{(z)}, specify the rotation angles for the cuboid region along the x, y and z axes. It should be noted that the coordinate parameters xₘ, yₘ, zₘ, may be defined in the global coordinate system, and can be obtained by the coordinate transformation between local and global coordinate systems.

The estimated bounding region parameters ĉₘ may be received by each device in the plurality of devices from a bounding region module (e.g. a networked computing device or portion thereof) configured to determine or estimate a bounding region for each object in the region of interest, as discussed elsewhere herein.

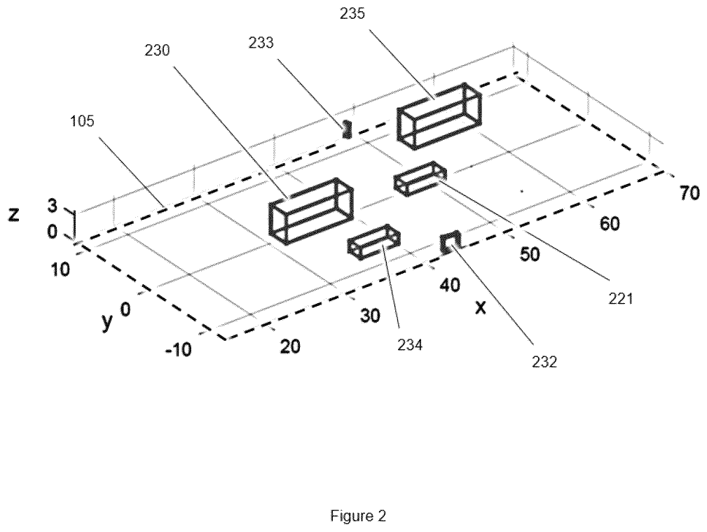

FIG. 2 illustrates an example of six objects in a region of interest, each object having a respective 3-D cuboid bounding region with zero rotation angles. Each illustrated cuboid bounding region, namely Region0 230, Region1 221, Region2 232, Region3 233, Region4 234, and Region5 235, corresponds to an object, namely Object0 130, Object1 121, Object2 132, Object3 133, Object4 134, and Object5 135, respectively, in the region of interest 105 illustrated in FIG. 1 of the target device 110.

In embodiments, a device n may determine (and hold) an object sensing data quality indicator Zₙ^{(m)} for each object m (in the region of interest and detectable by the device n) indicative of quality of respective object sensing data Dₙ^{(m)}. The object sensing data quality indicator Zₙ^{(m)} may be determined by the device, for example, using the respective bounding region parameters ĉₘ for each object m. The object sensing data and corresponding quality indicator thereof determined by the device for an object in the region of interest may inherently indicate that the object belongs to a set of objects in the region of interest of at least the target device. A device may use its own object sensing data to determine its own data quality indicators, thus reducing the need to communicate object sensing data to other devices for this purpose.

In embodiments, the data quality indicator may, for example, capture the amount and diversity of data of the object sensing data Dₙ^{(m)}, in terms of point number and spatial distribution. The amount and diversity of data affect the classification accuracy of the respective object classification task.

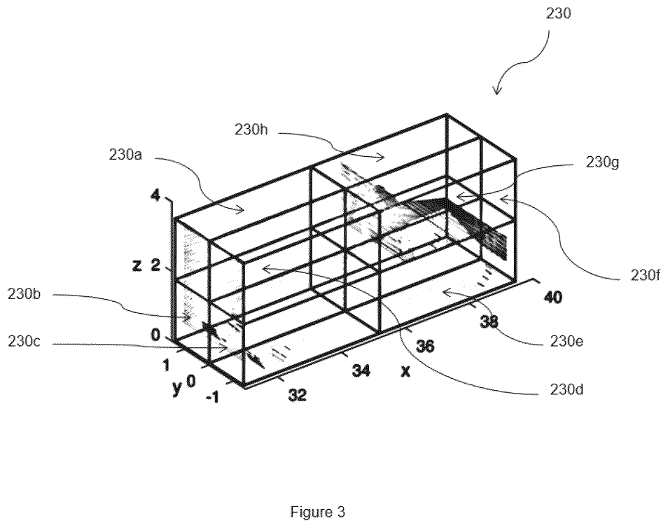

In an illustrative embodiment shown in FIG. 3, a 3-D cuboid bounding region (e.g. Region0 230) for object m (e.g. Object0 130 of FIG. 1) may be partitioned into K³ disjoint 3-D cuboid bounding sub-regions (bounding sub-regions 230a-230h) with K=2, where K denotes a partition resolution corresponding to the number of partitions along each axis. The lengths of each 3-D cuboid bounding sub-region along the x, y and z axes for object m are lₘ^{(x)}/K, lₘ^{(y)}/K, and lₘ^{(z)}/K respectively. The k-th (1≤k≤K³) element, Z_{n,k}^{(m)} in the object sensing data quality indicator Zₙ^{(m)} may denote (or be proportional to or an increasing function of) the number of observation points located inside the k-th cuboid bounding sub-region among all the observation points in the object sensing data Dₙ^{(m)}. In other embodiments, the number of partitions along each axis of a cuboid is not necessarily equal. An observation point can be an instance of object sensing data which pertains to a given point in space, e.g. due to a LIDAR reflection off a surface at that given point.

In embodiments, a bounding region module discussed herein, may be located at or be cooperatively coupled to the controller or one of the devices.

In embodiments, the bounding region module may be configured to receive or obtain, from devices, an abstract (or abstracted) sensing data. The abstract sensing data may be obtained or determined by each device from respective raw data Dₙ obtained by each device, for example, by downsampling the raw sensing data or by using occupancy map of the raw sensing data, or both. For example, each device may generate, from its raw sensing data, abstract sensing data which includes the same general information as the raw sensing data but at a lower granularity or resolution. Such abstract sensing data is thus less resource-intensive to transmit, but still usable for the purpose of determining bounding regions representing objects in the region of interest.

In embodiments, the bounding region module may fuse (e.g. combine, process) all instances of abstracted sensing data as received from all respective devices. Based on this abstracted sensing data, the bounding region module generates and defines bounding region parameters (e.g. the 9-tuple ĉₘ discussed elsewhere herein). Each instance of (estimated) bounding region parameters indicates the boundaries of a regular (e.g. cuboid) spatial region containing an object (or potential object) in the region of interest. Thus, the bounding region module can define the general locations, sizes and, possibly, shapes of objects, which are to be subsequently classified. Bounding region detection can be performed for example by detecting clusters of spatial points in a LIDAR (light detection and ranging) point cloud or abstracted version thereof, for example. Examples of bounding region detection are described in prior art, for example, in Efficient L-shape fitting for vehicle detection using laser scanners by Xiao Zhang et al in Proc. IEEE IV'17, pages 54-59, 2017; and in A fast and accurate segmentation method for ordered LiDAR point cloud of largescale scenes by Ying Zhou et al in IEEE Geosci. Remote. Sens. Lett., 11(11):1981-1985, 2014.

In embodiments, the object sensing data quality indicators may be communicated (e.g. sent, transmitted) to a controller, for example, in response to receiving, by the device, a corresponding request from the controller. In another example, the object sensing data quality indicators may be communicated to the controller automatically (e.g. via pre-configuration of the device) after determining (some or all of) the object sensing data quality indicators. The controller may be a network controller. The controller may include features and functions as understood by a person skilled in the art. The controller may be configured to enable (e.g. perform, facilitate) some or all features of the systems and methods disclosed herein.

In embodiments, the controller may be deployed in or operatively coupled to the network enabling communication between each of the devices and the controller. For example, the controller may be located at an RSU or associated edge server. In some embodiments the controller is located at an AV, such as the target device.

In embodiments, a system may include the controller and a group of devices, including a target device. Devices in the group of devices and the controller are in communication with each other, for example, via wireless communication links therebetween. The devices and the controller in the system may be configured in accordance with various features and methods of the present disclosure.

In embodiments, the controller receiving object sensing data quality indicators from the plurality of devices may provide, to each such device (or at least one such device), an indication of one or more of the instances of the object sensing data Dₙ^{(m)}. Such an indication may indicate that the one or more of the instances of the object sensing data Dₙ^{(m)} are to be used in each of one or more object classification tasks for classifying a respective one of the set of objects. Such indication may be sent by the controller to each (or at least one) device and may indicate, to the device, which of its held object sensing data Dₙ^{(m)} instances are to be used for the classification task of an object. Thus, the controller may use the received data quality indicators to determine the object sensing data instances to be used in a given object classification task.

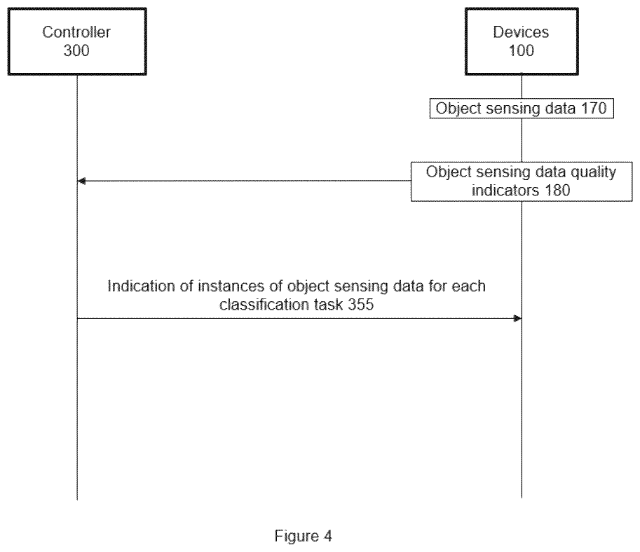

In an illustrative embodiment shown in FIG. 4, each device n 100 in a plurality of devices obtains and holds instances of object m sensing data Dₙ^{(m)} 170. Each device n 100 also determines object sensing data quality indicators Zₙ^{(m)} 180 indicative of quality of a respective instance of object m sensing data and communicates indicators Zₙ^{(m)} 180 to a controller 300. The controller 300 determines respective one or more instances of object sensing data Dₙ^{(m)} to be used in each of one or more object classification tasks and provides a corresponding indication 355 thereof to each device n 100. Although the term “each” device is used here, it should be understood that some devices may not necessarily generate data or generate and send indicators, and the controller may not necessarily send indications to all devices. For example, if a device does not have data for an object in the region of interest, it may refrain from sending a data quality indicator. If no data from a device is to be used for classification tasks, the controller may refrain from sending indications to that device.

In embodiments, the providing of an indication by the controller of an instance (of the object sensing data Dₙ^{(m)}) to a device n is based (at least in part) on a data selection decision sₙ^{(m)}. The data selection decision includes selecting or determining by the controller which instances of the object sensing data held by respective devices are to be used in respective object classification tasks. The controller may then send corresponding data selection indications to the devices, indicating to each device n that its instance Dₙ^{(m)} of the object sensing data for an object m is to be used in the respective object classification task of the object m. The data selection decision (or the indication thereof) may be denoted by s={sₙ^{(m)}, ∀ₘ ∈ [symbol] , ∀ₙ ∈ [symbol] }, where binary decision variable sₙ^{(m)}=1 indicates that the (instance of) object sensing data Dₙ^{(m)} held by the device n is used for task m, and sₙ^{(m)}=0 otherwise.

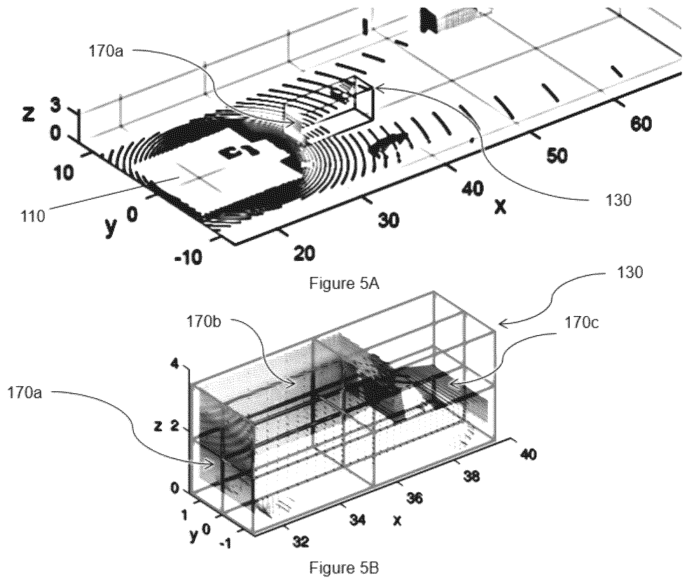

For example, as shown in an illustrative embodiment of FIGS. 5A and 5B, a first device being the target device (AV0 110) can provide one respective instance of object sensing data (170a) (e.g. D₀⁽⁰⁾) for an object (Object0 130) having a bounding region (Region0 230) only of the rear of said object. This is because the target device AV0 110 is immediately behind the object Object0 130. Such limited object sensing data (170a) may be insufficient for sufficiently accurate (e.g. above a predetermined classification accuracy threshold) classification of the object. However, other devices, such as AV1 121a shown in FIG. 1, may provide other respective instances of object sensing data (i.e. 170b, 170c, collectively D₁⁽⁰⁾) of the same object (Object0 130). Using instances of the object sensing data provided by different devices for the same object, contributes to increasing the classification accuracy for the corresponding object classification task. As shown in FIG. 5B, AV1 121a can provide object sensing data 170c of the front of Object0 130 and further object sensing data 170b of the left side of Object0 130. In various embodiments, the controller may provide the classification accuracy estimates to one, some or all of the devices.

In embodiments, a classification accuracy âₘ for a classification task of object m may be determined (or estimated), for example, using a pre-trained deep neural network (DNN) model or another machine learning technique. Using such machine learning, the classification accuracy for the classification task using selected (e.g. candidate) instances of object sensing data (as represented in a corresponding data selection decision) may be determined. Using the DNN modelling approach as an example, the classification accuracy may be denoted herein as âₘ=f^{DNN} (Z^{(m)}, lₘ^{(x)}, lₘ^{(y)}, lₘ^{(z)}), where lₘ^{(x)}, lₘ^{(y)}, lₘ^{(z)} are dimensions of a bounding region for object m received by the controller from a bounding region module, and Z^{(m)}= [symbol] sₙ^{(m)} gₙ^{(m)} Zₙ^{(m)} denotes a fused object sensing data quality indicator of all respective selected instances of object sensing data and depends on the data selection decision s and optional data resolution decision g. A classification accuracy requirement may be imposed such that âₘ≥∀, ∀ₘ ∈ [symbol] where A is a predetermined classification accuracy threshold. It is noted that the classification accuracy as defined here is independent of six of the nine values in the 9-tuple ĉₘ, thus simplifying the DNN model.

Accordingly, the classification accuracy for an object can be estimated using a technique such as machine learning, based on the dimensions of the object's bounding region, and further based on the data quality indicator. For example, when the data quality indicator indicates that a sufficient number of data points are available and sufficiently well-distributed throughout the bounding region, the classification accuracy can be considered to be relatively high. Higher numbers of data points and good (e.g. even) distribution can lead to higher classification accuracy. Using these values and a number of appropriate training examples, a machine learning model can be generated which accurately predicts object classification accuracy. Other heuristic techniques or functions may potentially be used in place of machine learning for predicting classification accuracy.

In embodiments, the controller may select that a particular device n is to provide its instance of the object sensing data Dₙ^{(m)} (i.e. data for object m held by the device n) for use in a particular object classification task. This selection may be based, at least in part, on a corresponding object sensing data quality indicator Zₙ^{(m)} indicative of quality of the instance of the object sensing data Dₙ^{(m)}.

For example, as discussed previously with respect to FIG. 1, the quality of object sensing data of Object1 121 held by AV4 121d may be low (or AV4 121d may be unable to obtain any sensing data of Object1 121) because Object1 121 is substantially blocked from AV4 121d by AV2 121b. (This is assuming that sensor(s) of AV4 121d are incapable of penetrating AV2 121b in order to obtain sensing data of Object1 121.) The controller may determine that low quality of object sensing data, as represented by a corresponding object sensing data quality indicator communicated by AV4 121d to the controller, is not needed for a classification task of Object1 121. The instance of object sensing data having a low object sensing data quality indicator capturing the respective sensing data amount, data diversity, or both (e.g. which may be represented in terms of point number and spatial distribution of sensing data points) might therefore be omitted from the classification task of the respective object. This reduces communication and computation overhead.

In embodiments, the controller may determine or select a resolution for an instance of the object sensing data. For example, a device in close proximity to an object to be classified may obtain object sensing data of higher quality compared to another device further away from the object. Transfer, between devices, of higher quality data generally requires more communication resources (e.g. bandwidth, time to transmit data) potentially resulting in longer time for a classification task of an object. Such higher quality data may not necessarily be essential to classify the object with sufficient accuracy (as predetermined for example by an accuracy threshold). In such case, the controller may select or determine a resolution for some or all instances of object sensing data for some or all object classification tasks, which may be represented as a data resolution decision by the controller. The data resolution decision may be denoted by g={gₙ^{(m)}, ∀ₘ ∈ [symbol] , ∀ₙ ∈ [symbol] }, where gₙ^{(m)} ∈[0, 1] indicates the ratio between the number of observation points in a particular instance of object sensing data of object m held by a device n after and before data downsampling at the device n for object m. Thus, the controller may determine that, for at least one object and at least one device, the object sensing data for that object, and held by that device, is to be downsampled by a specified amount prior to usage, including data transmission (if applicable) and data processing. It should be noted that the controller may determine that none of the object sensing data is to be downsampled. Downsampling may involve, for example, merging (e.g. averaging) multiple data points together or filtering out some of those data points, when those data points indicate locations in close physical proximity to one another. For example, in a rectangular grid of data points, each indicative of a LIDAR return signal for a 1 cm×1 cm region, the data points can be downsampled by merging 10×10 sub-grids of data points to produce a single data point indicative of an average LIDAR return signal for a 10 cm×10 cm region, or by filtering out some (which may be randomly selected or selected according to a predetermined rule or method) of the 10×10 sub-grids of data points. Downsampling may involve lossy data compression of object sensing data, to produce a version of object sensing data which contains less information but which generally indicates features of the original object sensing data.

In an embodiment, the data resolution may be selected for all instances of object sensing data held by all devices.

In another embodiment, the data resolution may be selected for some instances of object sensing data, and for some or all devices. This may be based, for example, at least in part on a corresponding object sensing data quality (or indicator thereof) for an instance of object sensing data. One or more corresponding data quality metrics may be provided, for example. If data quality (or indicator(s) thereof) of a particular instance of object sensing data does not meet the predetermined data quality metrics, then the controller may select (as part of the data resolution decision) a lower data resolution (e.g. by indicating a downsampling degree for the object sensing data) for the particular instance to reduce the communication resource consumption in transferring that particular instance of object sensing data between devices (while also enabling sufficient accuracy of the classification task of the object requiring the particular instance of the object sensing data). In another example, the controller may select the lower data resolution for the particular instance based (at least in part) on an estimated communication time to transmit said particular instance (or all instances to be transmitted) to a device selected to perform a corresponding object classification task exceeding a predetermined data transmission threshold (or predetermined communication time). Therefore, data resolution can be decreased as long as other object classification objectives are still satisfied. This has the effect of allowing for adequate object classification to occur in a resource-efficient and timely manner.

In embodiments, the controller may provide a data resolution indication based on the data resolution decision to one or more devices holding respective instances of object sensing data. Such indication can indicate to the device to downsample its respective instance of object sensing data by a specific degree (e.g. ratio), as indicted by the received indication, before use of said respective instance (e.g. and before transmitting the respective instance to a device selected to perform an associated object classification task).

In embodiments, the controller may select or determine a particular device to perform a classification task of a specified object. The corresponding task placement decision eₙ^{(m)}, indicates that the device n′ of a plurality of devices [symbol] is to perform a classification task of the object m. Set [symbol] is equal to the union of the set [symbol] with other available computing devices (if any), such as edge servers or RSU computing components. Thus, the set of sensing devices can be different from the set of computing devices. Such task placement decision (or an indication thereof) may be denoted for example by e={eₙ^{(m)}, ∀ₘ ∈ [symbol] , ∀n′ ∈ [symbol] }, where binary decision variable e_{n′}^{(m)}=1 indicates that classification task of object m is to be placed at computing node n′, and e_{n′}^{(m)}=0 otherwise. The controller may make such determinations for some or all specified objects in the region of interest. Thus, the controller specifies certain devices to perform classification for certain objects.

In embodiments, the controller may further provide to at least one of the plurality of devices, one or more task placement indications based on the task placement decision. Each task placement indication may indicate that a specified one of the object classification tasks is to be performed at a specified one of the plurality of devices. Such task placement decisions (and corresponding indications thereof) may be determined jointly with other decisions, such as data selection decisions (and corresponding indications thereof of one or more of the instances of the object sensing data to be used in each of one or more object classification tasks).

In some embodiments, the primary decision may be task placement, and other decisions, such as data selection, are not necessarily made by the controller. For example, at least one of the task placement indications may include or be integrated together with the indication of one or more of the instances of the object sensing data to be used in each of the one or more object classification tasks.

For example and referring to FIG. 1, the controller may identify (based at least in part on respective object sensing data quality indicators) four devices as part of a data selection decision for classification task of Object0 130: device AV0 110, device RSU 122, device AV1 121a, and device AV3 121c. Somewhat equivalently, the controller may specify, as part of a data selection decision, that (s_{AV0}^{(Object0)}), s_{RSU}^{(Object0)}, s_{AV1}^{(Object0)}) and (s_{AV3}^{(Object0)}) are all set equal to one. Each of the four selected devices is to provide respective four instances of object sensing data for Object0 130 to be used in the classification task of Object0 130. (The device which performs this classification task by receiving and processing these instances of object sensing data may be selected in a task placement decision, also potentially made by the controller, as specified below.)

In an embodiment, the controller may send an indication of each of the data selection decisions to respective each of the four devices indicating that their respective instances of object sensing data of Object0 130 are to be used in the classification task of Object0 130. In addition or alternatively, the controller may send such indication to a device selected to perform the classification task of Object0 130.

In embodiments, the controller may indicate to the device that the device is to perform a (one or more) classification task of a specified object (or object classification task). The controller may select, for example, device AV0 110 as a task placement decision e_{AV0}^{(Object0)} for classification task of Object0 130.

In an embodiment, the controller may send a corresponding indication of a task placement decision to each of the four devices indicating to these devices where to send the respective four instances of object sensing data of Object0 130, i.e. to the device AV0 110. Such an indication received by each of the four devices may further include (or be equivalent to) an indication of corresponding data selection decision indicating to each of the four devices that the respective held instances of the object sensing data are to be used in classification task of Object0 130. Such indication of the task placement decision received by each (or at least one) of the four devices may also indicate to at least one of the four devices that it is to provide, to a device selected for classification task of Object0 130, its held instance of the object sensing data of Object0 130. For example and referring to FIG. 1 discussion above, device RSU 122, device AV1 121a, and device AV3 121c receiving a task placement indication indicating that classification task of Object0 130 is to be performed by device AV0 110. These devices may, in response, send respective instances of object sensing data of Object0 130 to the device AV0 110. In other words, receiving the task placement indication by a device in itself may comprise or imply the data selection indication indicating to the device that the object sensing data it holds is to be used in the classification task of the respective object. In such case, if a device does not receive a specific task placement indication, then respective object sensing data held by said device may, by default, be unused in the classification task of the object.

In addition or alternatively, the controller may send the indication of a task placement selection decision to the selected device AV0 110 indicating that it is to perform the classification task of Object0 130. In another embodiment, if device AV0 110 receives such indication in addition to receiving the indication of the data selection decision discussed above with respect to the four devices (AV0 110, RSU 122, AV1 121a, AV3 121c), then the device AV0 110 may send a corresponding request to each of the four devices, other than itself, to send respective instances of object sensing data to AV0 for use in the classification task of Object0 130. AV0 also uses its own local data for use in the classification task. It is typical but not an absolute requirement that a device performing a classification task will use its own local data in such a task. A device using its own local data in a classification task generally thereby causes a reduction in data transmission and associated delays.

In another example, and referring to FIG. 1 discussion above, the controller may send the task placement indication to all devices selected to perform at least one object classification task. In this case, each device (or at least one device) receives information indicative of the device(s) at which specified classification task(s) is (or are) to be performed. Such task placement indication does not necessarily comprise the data selection indication which may be sent separately by the controller to devices (and indicative of which instances of object sensing data are selected to be used in the classification task of the corresponding object). In other words, the task placement indication and the data selections indication may be sent as separate indications, although corresponding decisions (task placement and data selection) may be determined jointly by the controller.

In an embodiment, as mentioned above, if an instance of the object sensing data to be used for the classification task of a particular object is held by a device that is also selected to perform the classification task of said particular object, then transmitting of this object sensing data can be omitted because such data is already held by the same device.

In embodiments, the classification tasks for each object in the region of interest may be assigned by the controller to one or more devices, depending at least in part on the number of the devices available to perform at least one object classification task. The controller, instead of collecting object sensing data and sending it to selected nodes to perform classification tasks, may facilitate sharing (or sending, transmission, communication) of object sensing data directly between devices holding the respective instances of object sensing data and the devices selected by the controller to perform the classification tasks for which said respective instances of object sensing data are required. Devices may thus transmit data to one another directly or else via an intermediary which may be the controller or another one or more devices. A device may perform one, two or more object classification tasks.

In embodiments, the controller may allocate (e.g. determine, assign) resources for use in each of associated one or more of object classification tasks. The allocated resources may be resources used by devices to perform object classification tasks, such as computing resources, communication resources, or a combination thereof. The controller may communicate indications of the allocated resources to the devices performing the object classification tasks, the devices providing object sensing data to be used in the object classification tasks, other communication infrastructure devices, or a combination thereof. The devices may then use the assigned resources in performing object classification tasks, while refraining from using more than the assigned resources in performing the object classification tasks.

In embodiments, the allocated resources may include computing resources an, to be used by a selected device n′ in support of (e.g. and in performing) an associated one or more of object classification tasks to be performed at the device n′. Computing resources a_{n′} may be expressed as a fraction of the total computing resources of device n′ which are made available for object classification. Computing resources may include processor time allocations, number of processors, threads, memory or cache allocations, or the like, or a combination thereof.

In an embodiment, the computing resources a_{n′} may be allocated for use in all object classification tasks which are to be performed at the selected device n′. In an embodiment, when a selected device performs multiple object classification tasks, a fraction of computing resources of the device may be allocated for use in each such task.

In embodiments, the allocated resources may include communication resources β_{n,n′} to be used for communication (e.g. transfer of a respective one or more instance of object sensing data) between a device n holding a respective (one or more) instance of object sensing data to the device n′ selected to perform a (respective one or more) classification task of the respective (one or more) object. The communication resources n, may be determined for a specified individual transfer of a single instance of the object sensing data. The communication resources β_{n,n′} may be determined for total transfer of all (or at least one) instances of object sensing data between a specified two devices, or between a selected pair of devices, such as a device providing an instance of object sensing data and a device performing object classification based at least in part on this instance of object sensing data. The communication resources may be determined for some or all communication required between two or more devices for performing one or more object classification tasks. Communication resources may include spectral resources such as channels, sets of spreading codes, time slots, or frequency bands, or the like, or a combination thereof.

For example and referring to FIG. 1, suppose device AV0 110 is selected to perform classification task of Object0 130 and Object4 134. Suppose further that respective instances of object sensing data for the classification task of Object0 130 are to be provided by device AV0 110, device RSU 122, device AV1 121a, and device AV3 121c. Suppose further that respective instances of object sensing data for the classification task of Object4 134 are to be provided by device AV0 110, device AV1 121a, and device AV3 121c. In this case, the communication resources β_{AV1}, AV0 may be allocated for total transfer of instances of object sensing data D_{AV1}^{(Object0)} and D_{AV1}^{(Object4)} for respective object classification tasks from device AV1 121a to device AV0 110. Similar communication resources may be allocated for transfer of object sensing data from AV3 to AV0. AV0 does not need to communicate (via external channels) its own object sensing data to itself. Resource allocation decision may be denoted by a={a_{n′}, ∀n′ ∈ [symbol] } and β={β_{n,n′}, ∀n ∈ [symbol] , ∀n′ ∈ [symbol] }, where a_{n′} represents a fraction of computing resource usage at a device n′ allocated for use in performing one or more object classification tasks at or by the device n′; and β_{n,n′} represents the fraction of bandwidth allocated to the communication link (or for transfer of respective one or more instances of object sensing data) from a device n holding a respective (one or more) instance of object sensing data to the device n′ selected to perform a (respective one or more) classification task of the respective (one or more) object. As formulated above, resource allocation decisions are made for devices, irrespective of tasks. In other embodiments, resource allocation decisions may be made which are specific to a task.

In embodiments, the controller may determine allocation of resources jointly with data selection decisions and corresponding indications thereof of one or more of the instances of the object sensing data to be used in each of one or more object classification tasks.

It is also noted that communication and computing resource allocation decisions may be made in cooperation with data resolution decisions. Downsampled data requires less resources to communicate and compute, and thus resource allocations can be adjusted accordingly.

In an embodiment, the controller may allocate resources (at least in part) to minimize or limit (e.g. to be at or below a predetermined threshold) a (e.g. expected or estimated) computing time for completion of each of the associated one or more of the object classification tasks at (or by) a specified (or selected) device. In another embodiment, the controller may allocate resources (at least in part) to minimize or limit (e.g. to be at or below a predetermined threshold) a (e.g. expected or estimated) communication time for communication between the specified device and other one or more devices selected to provide respective instances of object sensing data to the specified device in support of each of the associated one or more of the object classification tasks. In another embodiment, the controller may allocate resources (at least in part) to minimize or limit both the computing time and the communication time expressed, for example as a combination such as a weighted or unweighted sum.

In embodiments, multiple devices can communicate (e.g. provide their respective instances of object sensing data) with an AV selected for one or more of the object classification tasks simultaneously by using other transmission schemes, such as Non-Orthogonal Multiple Access (NOMA).

The computing time may, for example, depend on a computing demand for each object classification task. The (e.g. estimated) computing demand or requirement for a classification task of object m may be denoted by μ^{(m)} and expressed (e.g. measured, estimated, evaluated) in CPU cycles or another appropriate metric. A computation intensity (in CPU cycle/point) denoted as E may represent an average number of CPU cycles for computing one observation point in object sensing data at (or by) a selected device n′. The computing demand may depend on a total number of observation points in all the selected instances of object sensing data from devices n holding (and providing) such instances, expressed as: μ^{(m)}=ϵ [symbol] sₙ^{(m)}gₙ^{(m)}|Dₙ^{(m)}|. Because, in embodiments, each device n′ may be selected to perform (or support) more than one object classification task, the computing demand μₙ, for all the object classification tasks to be performed at the selected device n′ may be expressed as: μ_{n′}= [symbol] e_{n′}^{(m)} μ^{(m)}. The computing time for all the object classification tasks to be performed at the selected device n′, denoted by t_{n′}, may be expressed as:

$${t}_{n ′} = \{ \begin{matrix}{μ}_{n ′} / {f}_{n ′} {α}_{n ′} , & ∀ {n}^{′} ∈ {𝒩}^{+} if {α}_{n ′} > 0 \\ 0 , & ∀ {n}^{′} ∈ {𝒩}^{+} if {α}_{n ′} = 0\end{matrix} ,$$

where fₙ, denotes the amount of available computing resources (in cycle/s) at selected device n′.

The communication time may, for example, depend on the size (e.g. in bits) of object sensing data being communicated. The total size of all instances of object sensing data to be transmitted from each respective device n to a selected device n′ for performing of all object (respective) classification tasks at or by the device n′, denoted by ρ_{n,n′}, may be expressed as: ρ_{n,n′}=φ [symbol] sₙ^{(m)}gₙ^{(m)}|Dₙ^{(m)}|, where φ denotes the object sensing data size (in bits) of one observation point in object sensing data. Orthogonal frequency division multiplexing (OFDM) based vehicle-to-everything (V2X) transmissions, for example, may be used for communication between devices. An average transmission rate over a communication link from the respective device n to the selected device n′, denoted by R_{n,n′}, may be expressed as:

$${R}_{n , {n}^{′}} = {β}_{n , {n}^{′}} B {log}_{2} ( \frac{1 + {P}_{n} {\vert {h}_{n , n ′} \vert}^{2} {d}_{n , n ′}^{- γ} )}{{σ}^{2}} ) ,$$

where B denotes a total bandwidth of a link spectrum shared between all devices; Pₙ denotes an uplink transmit power of the respective device n; h_{n,n′} denotes a channel fading coefficient from the respective device n to the selected device n′; d_{n,n′} denotes a distance between the respective device n and the selected device n′; γ is a path loss exponent; and σ² represents a noise power. For example, for simplicity assuming a constant distance d_{n,n′} during the perception task period, with the consideration of low latency requirement for the perception task, the transmission time for all the sensing data transmitted from the respective device n to the selected device n′, denoted by t_{n,n′}, may be expressed as:

$${t}_{n , n ′} = \{ \begin{matrix}{ρ}_{n , {n}^{′}} / {R}_{n , {n}^{′}} & ∀ n ∈ 𝒩 , ∀ {n}^{′} ∈ {𝒩}^{+} if {β}_{n , {n}^{′}} > 0 \\ 0 , & ∀ n ∈ 𝒩 , ∀ {n}^{′} ∈ {𝒩}^{+} if {β}_{n , {n}^{′}} = 0\end{matrix} .$$

However, in other embodiments, such an assumption of constant distance d_{n,n′} might not be made.

The combined (or total) computing time and the communication time for all the object classification tasks may be expressed as: [symbol] (( [symbol] t_{n,n′})+t_{n′})≤T, where T is a predetermined combined (or total) time threshold. Here, for simplicity, it can be assumed that all the respective devices n that are selected to provide object sensing data to other selected devices n′ begin data transmission simultaneously. It may also be assumed, for simplicity, that the computation at a selected device n′ may be performed once the selected device n′ receives all respective instances of object sensing data for all the associated object classification tasks. This scenario leads to the combined computing and communication time expression above. Other combined computing and communication time expressions are also possible.

By using computing time, communication time, or a combination thereof as a factor (e.g. in a constraint or an objective function) in decision making (e.g. data selection, task placement, data resolution and resource allocation decisions), the controller can facilitate performing object classification in a timely manner, which is important for vehicle control in a dynamic environment.

Although a specific formulation is given above for given assumptions, this is provided as an example only and the formulation can be varied in many ways, as will be readily understood by a worker skilled in the art.

In an embodiment, the controller may allocate resources to minimize or limit a total resource consumption cost o. The total resource consumption cost may include a weighted or unweighted sum of the computing resources a_{n′} to be used by each specified device n′ in support of all associated object classification tasks at the selected (or specified) device n′, and a weighted or unweighted sum of the communication resources β_{n,n′} to be used for communication between each specified pair (i.e. device n and device n′) of the plurality of devices in support of all (associated) object classification tasks. The total resource consumption cost may be denoted as: o=ωB [symbol] [symbol] β_{n,n′}+(1−ω) [symbol] a_{n′}f_{n′}. Here, f_{n′}, ω and B are predetermined parameters. Other cost or objective functions can also be used.

In various embodiments, and more generally, the controller may make decisions in order to minimize (globally or locally) or limit a cost function, or equivalently maximize (globally or locally) or provide for an adequately high objective function. The decisions may further be made in such that one or more hard or soft constraints are satisfied. The cost function, objective function, can reflect one or a combination of factors, such as time taken to perform object classification, object classification accuracy, resource usage, safety, probability of error, or the like. The constraints can also reflect one or a combination of factors of the same type. Thus, the controller may solve or approximately solve an optimization problem. The decision variables of the optimization problem can represent resource allocation decisions, task placement decisions, data selection decisions, data resolution decisions, or the like, or a combination thereof. For example, the decision variables can be data selection decisions. As another example, the decision variables can be task placement decisions. As another example, the decision variables can be resource allocation decisions. As another example, the decision variables can be data resolution decisions. As another example, the decision variables can be any two, three or four of resource allocation decisions, task placement decisions, data selection decisions, and data resolution decisions. Various approaches for solving or approximately solving an optimization problem may be used, as will be readily understood by a worker skilled in the art.

In embodiments, a device n selected to support object classification tasks at the device n, may perform said object classification tasks in compliance with indications (e.g. of respective data selection, data resolution, task placement decisions) provided by the controller, allocations (e.g. of computing resources, communication resources) provided by the controller, or both.

In one embodiment, an approach for solving or approximately solving the optimization problem may include an outer module and an inner module.

The outer module may provide a candidate solution, determined using the genetic algorithm, which includes jointly determined data selection, subtask placement and (optional) data resolution decisions that are feasible at least in terms of the accuracy and topology constraints (e.g. single computing node placement constraint for each object classification task, half-duplex communication constraints of each AV), to the inner module. The inner module may check the feasibility of such candidate solution for optimizing the resource allocation (decision) for a minimal total resource consumption cost o under a constraint of a predetermined total (computing and communication) time threshold.

Given the candidate solution (candidate s, e, g decisions), the inner module can determine resource allocation decision that minimizes the total resource consumption cost o by determining the (total) computing and communication time while satisfying the total time threshold T given the available (or candidate) computing and communication resources.

In embodiments, the controller may determine an indication of one or more instances of object sensing data to be used in each of one or more object classification tasks based, at least in part, on context information. The context information can be encoded into cost or objective functions, or constraints, or both, of the optimization problem, for example.

In embodiments, the context information may include network topology of at least those devices that are involved in or support the various methods and system disclosed herein. Devices obtaining respective instances of object sensing data for objects in the region of interest may move at their respective speeds in their respective directions or be stationary. Devices may move closer to or further away from the region of interest. As a result, the network topology may change over time. Communication of a device with the network may be interrupted, for example, by an obstacle impacting the communication, or as a result of an internal communication system failure of the device.

In embodiments, the context information may include resource availability. The resource availability may include information indicative of computing and communication resources available at each device. The resource availability may include information indicative of a number of devices available to provide object sensing data for objects in the region of interest. It should be noted that the information indicative of a number of devices available to provide object sensing data for objects in the region of interest may be (implicitly or explicitly) included in object sensing data quality indicators and, in such case, may be omitted from additional resource availability context information. Resource availability information may be used by the controller in allocating resources for use in each of associated one or more of object classification tasks.

In embodiments, the context information may include quality of service (QoS) requirement information. Network and device QoS requirements may be preset (e.g. predetermined, fixed) and may therefore be substantially constant over time.

In embodiments, the context information may be obtained by the controller, by another network element configured to obtain and provide context information to the controller, or both.

In embodiments, some context information may be obtained by the controller substantially continuously, for example, if a specific instance of the context information can vary irregularly over time, such as use of and possible congestion (e.g. as a result of system maintenance, updates, or priority communication) of local communication resources among devices, or associated delays or limitations, or the like. Some context information may be substantially constant over a period of time, such as the QoS requirement discussed above, and therefore may be obtained periodically or updated as needed, for example, when a new device enters or nears the region of interest.

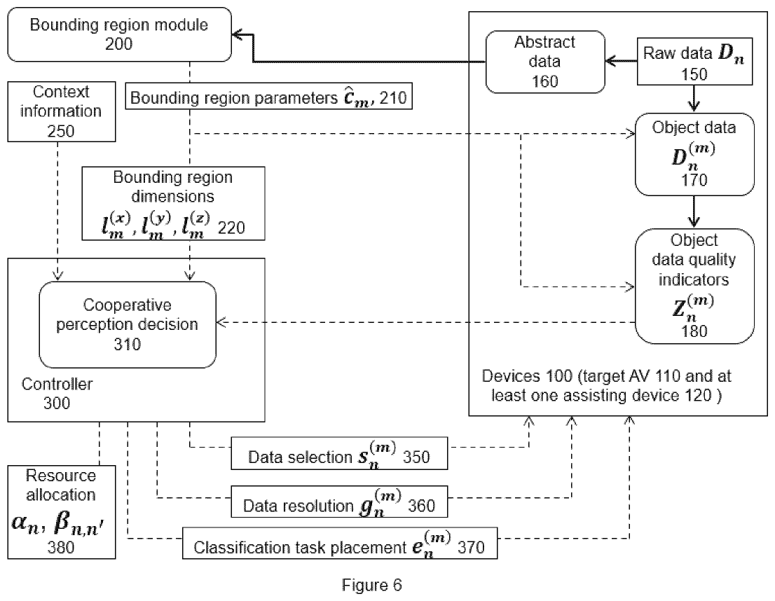

FIG. 6 illustrates components of a system for classifying objects, according to an embodiment of the present disclosure. The system 500 includes a plurality of devices 100 including a target device 110 and at least one other device 120, which may be another AV or a stationary device such as an RSU. Each device in the plurality of devices 100 can obtain respective raw sensing data 150 for a region of interest. Each device can obtain a respective abstract sensing data 160 from its raw sensing data 150, as described elsewhere herein. Each device may communicate its respective abstract sensing data 160 to a bounding region module 200. The bounding region module 200 can fuse or combine respective abstract sensing data 160 received from all devices in the plurality 100 to determine bounding region parameters 210 for each object in the region of interest which include dimensions 220 of a respective bounding region that contains or encompasses an object in the region of interest.

As further shown in FIG. 6, the bounding region module 200 sends the bounding region dimensions 220 to a controller 300, and the estimated bounding region parameters ĉₘ 210 to each device 100. Note that the bounding region dimensions are a subset of all estimated bounding region parameters ĉₘ Each device n 100 uses the received bounding region parameters 210 to obtain or extract respective object sensing data Dₙ^{(m)} 170 for at least one object m. Each device 100 further determines respective object sensing data quality indicators Zₙ^{(m)} 180 of respective object sensing data Dₙ^{(m)} 170 and sends the respective object sensing data quality indicators 180 to a controller 300.

The controller 300 may be configured to determine respective instances of object sensing data 170 to be used in classifications tasks of each object in the region of interest as part of cooperative perception sensing decision 310 (namely the data selection decision part of the overall decision 310). Additionally or alternatively, the controller may be configured to determine other aspects of the overall decision 310, such as the task placement decision, data resolution decision, resource allocation decision, or a combination thereof. The controller 300 determines the cooperative perception sensing decision 310 based at least on the respective object sensing data quality indicators 180, the bounding region dimensions 220, and context information 250 discussed elsewhere herein. The context information 250 may be received by the controller 300 from the network (not shown), each device 100, another device providing some or all of the context information 250 to the controller (not shown), or a combination thereof.

The controller 300 may provide indications of data selection 350, based on a corresponding data selection decision by the controller, to some or all of devices 100, as discussed elsewhere herein. The controller 300 may provide (optional) indications of data resolution 360, based on a corresponding data resolution decision by the controller, to some or all of devices 100, as discussed elsewhere herein. The controller 300 may provide indications of classification task placement 370, based on a corresponding task placement decision by the controller, to some or all of devices 100, as discussed elsewhere herein. The controller 300 may provide indications of resource allocations 380, based on a corresponding allocation of resources (decision) for object classification tasks as determined by the controller, as discussed elsewhere herein. The controller 300 may communicate an indication of resource allocation 380 to some or all of devices 100 (not shown).

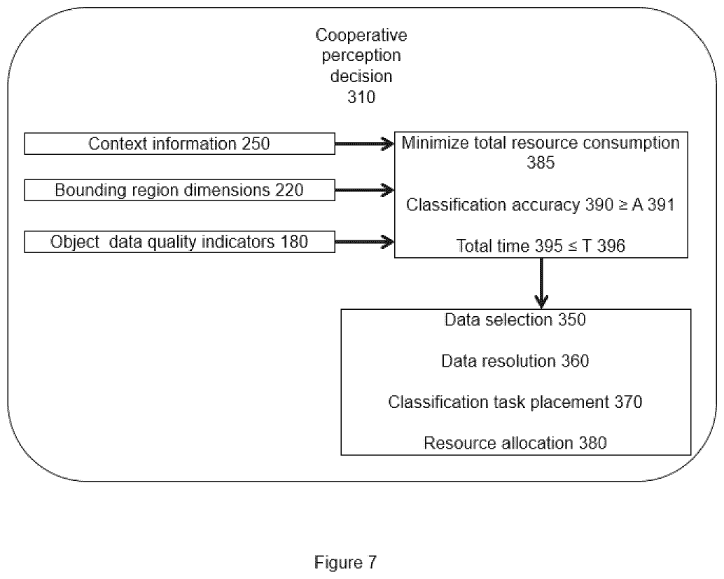

FIG. 7 illustrates a mechanism for cooperative perception, according to an embodiment of the present disclosure. The cooperative perception decision 310 includes receiving, by the controller, information that includes bounding region dimensions 220, object sensing data quality indicators 180, and context information 250. Such information is then used to determine one or more decisions for performing cooperative perception. These cooperative perception decisions can include one, some or all of data selection decisions 350, data resolution decisions 360, classification task placement decision 370, and resource allocation decisions 380. The data selection decision 350 indicates selected devices to provide their respective instances of object sensing data for object classification tasks. The data resolution decision 360 indicates resolution of object sensing data for object classification tasks. The task placement decision 370 indicates selected devices for each object classification task. The resource allocation decision 380 indicates computing resources, communication resources, or both, to be used in support of classification tasks. Such joint determining may be based on minimizing or limiting of total resource consumption 385 associated with object classification tasks while setting a classification accuracy 390 to be at or above a predetermined accuracy threshold 391, and setting a total time 395 associated with completion of all object classification tasks to be at or below a predetermined total time threshold 396. The joint determining may be performed by solving or approximately solving a constrained or unconstrained optimization problem.

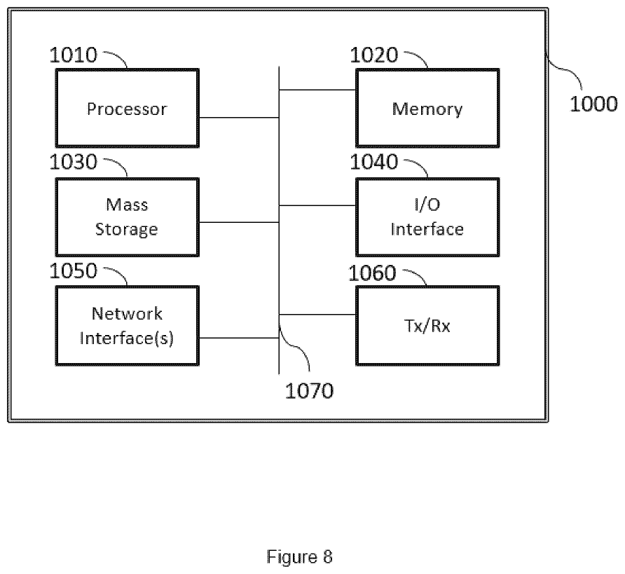

FIG. 8 is a schematic diagram of an electronic device 1000 that may perform any or all of operations of the above methods and features explicitly or implicitly described herein, according to different embodiments of the present disclosure. For example, a computer equipped with network function may be configured as an electronic device 1000. Such an electronic device may be used as part of one or more of: a controller, an edge server, a processing device, a bounding region module, an AV, an RSU, etc.

As shown, the device includes a processor 1010, such as a Central Processing Unit (CPU) or specialized processors such as a Graphics Processing Unit (GPU) or other such processor unit, memory 1020, non-transitory mass storage 1030, I/O interface 1040, network interface 1050, and a transceiver 1060, all of which are communicatively coupled via bi-directional bus 1070. According to certain embodiments, any or all of the depicted elements may be utilized, or only a subset of the elements. Further, the device 1000 may contain multiple instances of certain elements, such as multiple processors, memories, or transceivers. Also, elements of the hardware device may be directly coupled to other elements without the bi-directional bus. Additionally or alternatively to a processor and memory, other electronics, such as integrated circuits, may be employed for performing the required logical operations.

The memory 1020 may include any type of non′-transitory memory such as static random access memory (SRAM), dynamic random access memory (DRAM), synchronous DRAM (SDRAM), read-only memory (ROM), any combination of such, or the like. The mass storage element 1030 may include any type of non-transitory storage device, such as a solid state drive, hard disk drive, a magnetic disk drive, an optical disk drive, USB drive, or any computer program product configured to store data and machine executable program code. According to certain embodiments, the memory 1020 or mass storage 1030 may have recorded thereon statements and instructions executable by the processor 1010 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method comprising:
receiving, by a controller, object sensing data quality indicators, the object sensing data quality indicators determined by a plurality of devices including a target device, each object sensing data quality indicator indicative of quality of a respective instance of object sensing data, held by a respective one of the plurality of devices and indicative of a respective object belonging to a set of objects in a region of interest of at least the target device; and
providing, by the controller to at least one of the plurality of devices, an indication of one or more of the instances of the object sensing data to be used in each of one or more object classification tasks, each of the one or more object classification tasks for classifying a respective one of the set of objects.

2. The method of claim 1, wherein said providing the indication of one or more of the instances of the object sensing data comprises providing, to a particular device of said at least one of the plurality of devices, a data selection indication indicative that the instance of object sensing data, held by said particular device and indicative of a particular object belonging to the set of objects, is to be used in a particular corresponding one of the one or more object classification tasks.

3. The method of claim 2, wherein the particular device of said at least one of the plurality of devices is selected, by the controller, based at least in part on object sensing data quality indicators indicative of quality of respective instances of object sensing data held by said particular device.

4. The method of claim 1, further comprising providing, by the controller to said at least one of the plurality of devices, one or more task placement indications, each task placement indication indicative that a specified one of the one or more object classification tasks is to be performed at a specified one of the plurality of devices, wherein the task placement indications are determined jointly with the indication of one or more of the instances of the object sensing data to be used in each of the one or more object classification tasks.

5. The method of claim 4, further comprising, by the controller, allocating resources for use in each of said one or more object classification tasks, said resources including one or both of:
computing resources to be used by said specified one of the plurality of devices in support of an associated one or more of the object classification tasks; and
communication resources to be used for communication between said specified one of the plurality of devices and another specified one of the plurality of devices in support of the associated one or more of the object classification tasks,
wherein the controller performs said allocating resources jointly with determining the indication of one or more of the instances of the object sensing data to be used in each of said one or more object classification tasks.

6. The method of claim 5, wherein the resources are allocated at least in part to satisfy that: a combination of: a computing time for completion of each of the associated one or more of the object classification tasks, and a communication time for communication between said specified one of the plurality of devices and other specified one of the plurality of devices in support of each of the associated one or more of the object classification tasks, will be at or below a predetermined threshold.

7. The method of claim 5, further comprising, by the controller, communicating indications of the allocated resources to one or more of the plurality of devices, the plurality of devices using the allocated resources in performing the one or more object classification tasks and refraining from using more than the allocated resources in performing the one or more object classification tasks.

8. The method of claim 4, further comprising, by said specified one of the plurality of devices, performing said specified one of the object classification tasks according to the one or more task placement indications.

9. The method of claim 1, further comprising providing, by the controller to said at least one of the plurality of devices, one or more data resolution indications each indicative that an associated one of the instances of the object sensing data, to be used in each of the one or more object classification tasks, is to be downsampled by a specified degree prior to use in an associated object classification task, said use including transmission of object sensing data between members of the plurality of devices when required.

10. The method of claim 9, further comprising, by said at least one of the plurality of devices, downsampling said associated one of the instances of the object sensing data by the specified degree, according to the one or more data resolution indications.

11. The method of claim 1, further comprising, by the controller, allocating resources for use in each of said one or more object classification tasks, said resources including one or both of:
computing resources to be used by specified ones of the plurality of devices in support of an associated one of the object classification tasks; and
communication resources to be used for communication between specified pairs of the plurality of devices in support of the associated one of the object classification tasks,
wherein the controller performs said allocating resources jointly with determining the indication of one or more of the instances of the object sensing data to be used in each of the one or more object classification tasks.

12. The method of claim 11, wherein said allocating resources by the controller is performed so as to:
minimize or limit a total resource consumption cost comprising a weighted or unweighted sum of the computing resources to be used by each specified one of the plurality of devices in support of all associated object classification tasks, and a weighted or unweighted sum of the communication resources to be used for communication between each specified pair of the plurality of devices in support of all object classification tasks.

13. The method of claim 1, further comprising, by said at least one of the plurality of devices, performing the one or more object classification tasks in compliance with indications, allocations, or both indications and allocations provided by the controller, said indications including said indication of one or more of the instances of the object sensing data to be used in each of the one or more object classification tasks.

14. The method of claim 1, further comprising, determining the instances of object sensing data, said determining comprising, for each instance of the object sensing data:
sending, by a bounding region module configured to determine a bounding region for the object to be indicated by the instance of object sensing data, bounding region parameters for the bounding region to each of the plurality of devices; and
determining, by each one of the plurality of devices, the respective instance of object sensing data from raw sensing data obtained by said one of the plurality of devices, using the bounding region parameters.

15. The method of claim 14, further comprising providing the indication of the one or more instances of the object sensing data to satisfy that an estimated classification accuracy of each of the object classification tasks is at or above a predetermined classification accuracy threshold, the estimated classification accuracy determined by the controller based at least in part on the respective object sensing data quality indicators for each object classification task, in combination with dimensions of the bounding region for the object, the dimensions received by the controller from the bounding region module.

16. The method of claim 15, wherein the estimated classification accuracy of each of the one or more object classification tasks is indicated to the devices by the controller.

17. The method of claim 1, wherein at least the indication of one or more of the instances of the object sensing data is determined based on context information comprising one or more of: network topology context information, resource availability context information, and quality of service requirement context information.

18. The method of claim 1, further comprising, by the at least one of the plurality of devices, performing the one or more object classification tasks.

19. A system comprising:
a plurality of devices including a target device configured to determine object sensing data quality indicators, each object sensing data quality indicator indicative of quality of a respective instance of object sensing data, held by a respective one of the plurality of devices and indicative of a respective object belonging to a set of objects in a region of interest of at least the target device; and
a controller, configured to receive said object sensing data quality indicators, and provide to at least one of the plurality of devices, an indication of one or more of the instances of the object sensing data to be used in each of one or more object classification tasks, each of the one or more object classification tasks for classifying a respective one of the set of objects,
wherein each of the plurality of devices and the controller are in communication with each other.

20. A controller configured to:
receive object sensing data quality indicators determined by a plurality of devices including a target device, each object sensing data quality indicator indicative of quality of a respective instance of object sensing data, held by a respective one of the plurality of devices and indicative of a respective object belonging to a set of objects in a region of interest of at least the target device; and
provide to at least one of the plurality of devices, an indication of one or more of the instances of the object sensing data to be used in each of one or more object classification tasks, each of the one or more object classification tasks for classifying a respective one of the set of objects.
